(19) United States
(12) Patent Application Publication
(10) Pub. No.: US 2015/0279391 A1
(43) Pub. Date: Oct. 1, 2015

(54) DISSATISFYING CONVERSATION DETERMINATION DEVICE AND DISSATISFYING CONVERSATION DETERMINATION METHOD

(71) Applicant: NEC Corporation, Minato--ku, Tokyo (JP)

(72) Inventors: Yoshifumi Onishi, Tokyo (JP); Makoto Terao, Tokyo (JP); Masahiro Tani, Tokyo (JP); Koji Okabe, Tokyo (JP)

(73) Assignee: NEC Corporation, Tokyo (JP)

(21) Appl. No.: 14/438,720

(22) PCT Filed: Aug. 21, 2013
(86) PCT No.: PCT/JP2013/072242

§ 371 Date: Apr. 27, 2015

(30) Foreign Application Priority Data
Oct. 31, 2012 (JP) 2012-240755

(51) Int. Cl. G10L 25/63; G10L 15/02

(52) U.S. Cl. CPC G10L 25/63; G10L 15/02

(57) ABSTRACT

This dissatisfying conversation determination device include: a data acquisition unit that acquires a plurality of word data, and a plurality of phonation time data by target conversation participants; an extraction unit that extracts a plurality of specific word data configuring polite expression and impolite expression from the plurality of word data; a change detection unit that detects a point of change from polite expression to impolite expression by the target conversation participants based on the plurality of specific word data and the plurality of phonation time data; and a dissatisfaction determination unit that determines whether the target conversation is a dissatisfying conversation for the target conversation participants based on the result of the point of change detected by the change detection unit.

### TECHNICAL FIELD

The present invention relates to an analysis technique for a conversation.

### BACKGROUND ART

As one example of a technique for analyzing a conversation, a technique for analyzing telephone call data is available. For example, data of the telephone call performed in a department referred to as a call center, a contact center, or the like is analyzed. Hereinafter, such the department that professionally performs operations for handling telephone calls from customers about inquiry, complaint, and order regarding products and services will be expressed as a contact center.

Demands of customers asked to the contact center are frequently reflected with customer needs, satisfaction degrees, or the like, and therefore it is very important for a company to extract such emotions and needs of the customers from telephone calls with the customers in order to increase repeat customers. Therefore, various types of methods for extracting an emotion (anger, frustration, discomfort, or the like) and the like of the user by analyzing voices have been proposed.

PTL 1 to PTL 3 have disclosed the following methods. In the method disclosed in PTL 1, based on a dictionary database in which a familiarity degree is set for a text and each word obtained by recognizing voice of speaker, a familiarity degree of utterance is calculated. Then, in case that a difference between the familiarity degree of the speaker stored as a history and the familiarity degree of the utterance is at least a certain magnitude, the familiarity degree of the speaker is updated with the familiarity degree of the utterance. In the method disclosed in PTL 2, an input text is divided into word strings by morphological analysis. Using a word dictionary in which emotion information (politeness and friendship) for each word unit is quantified and registered, emotion information for respective words in the word string are synthesized and emotion information of the text is extracted. The method disclosed in PTL 3 is an emotion generation method for learning like/dislike emotion toward a specific person or thing, representing an emotional response differing for each user; and causing this emotional response to be adjustable depending on the attitude of the user.

### CITATION LIST

### Patent Literature

[PTL 1] Japanese Laid-open Patent Publication No. 2001-188779

[PTL 2] Japanese Laid-open Patent Publication No. S63 (1988)-018457

[PTL 3] Japanese Laid-open Patent Publication No. H11 (1999)-265239

### SUMMARY OF INVENTION

### Technical Problem

The proposed method in PTL 2 determines emotion information of the text based on the emotion information for each word, and the proposed method in PTL 3 extracts emotion of the user based on a voice tone of the user. In such methods, it is possible to extract a telephone call expressing no dissatisfaction of a speaker having a rough tone on average or a speaker using rude language on average erroneously as a dissatisfying telephone call. Further, the proposed method in PTL 1 merely determines the update of the familiarity degree of the speaker in the case that the difference in changes of the familiarity degree of the speaker has at least a certain magnitude. In the proposed method in PTL 1, there is no supposition for performing analysis on dissatisfaction of the speaker.

In view of such circumstances, the present invention has been made and provides a technique to accurately extract a dissatisfying conversation (one example thereof is a dissatisfying telephone call). The dissatisfying conversation herein refers to a conversation in which a participant to a conversation (hereinafter, expressed as a conversation participant) is supposed to have felt dissatisfaction with the conversation.

### Solution to Problem

Each aspect of the present invention employs the following configuration to solve the problems.

A first aspect relates to a dissatisfying conversation determination device. The dissatisfying conversation determination device of the first aspect includes:

a data acquisition unit that acquires a plurality of word data extracted from voices of a target conversation participant in a target conversation and a plurality of phonation time data representing a phonation time of each word by the target conversation participant;

an extraction unit that extracts a plurality of specific word data each configuring a polite expression or an impolite expression from the plurality of word data acquired by the data acquisition unit;

a change detection unit that detects a point of change from the polite expression to the impolite expression of the target conversation participant in the target conversation, based on the plurality of specific word data extracted by the extraction unit and the plurality of phonation time data regarding the plurality of specific word data; and

a dissatisfaction determination unit that determines whether the target conversation is a dissatisfying conversation by the target conversation participant based on a detection result of the point of change by the change detection unit.

A second aspect relates to a dissatisfying conversation determination method performed by at least one computer. The dissatisfying conversation determination method of the second aspect comprising:

acquiring a plurality of word data extracted from voices of a target conversation participant in a target conversation and a plurality of phonation time data representing a phonation time of each word by the target conversation participant;

extracting a plurality of specific word data each constituting a polite expression or an impolite expression from the plurality of acquired word data;

detecting a point of change from the polite expression to the impolite expression of the target conversation participant in the target conversation, based on the plurality of specific word data extracted by the extraction unit and the plurality of phonation time data regarding the plurality of specific word data; and

determining whether the target conversation is a dissatisfying conversation by the target conversation participant based on a detection result of the point of change.

Another aspect of the present invention may be a program that causes at least one computer to implement the respective configurations in the first aspect or may be a computer-readable recording medium recorded with such a program. This recording medium includes a non-transitory tangible medium.

### Advantageous Effects of Invention

Each of the aspects makes it possible to provide a technique for accurately extract a dissatisfying conversation.

### BRIEF DESCRIPTION OF DRAWINGS

The above-described object and other objects as well as features and advantages will become further apparent from the following description of preferred exemplary embodiments referring to the following accompanying drawings.

FIG. 1 is a conceptual diagram illustrating a configuration example of a contact center system in a first exemplary embodiment.

FIG. 2 is a diagram conceptually illustrating a processing configuration example of a telephone call analysis server in the first exemplary embodiment.

FIG. 3 is a diagram conceptually illustrating a processing unit according to an index value calculation unit.

FIG. 4 is a flowchart illustrating an operation example of the telephone call analysis server in the first exemplary embodiment.

FIG. 5 is a diagram conceptually illustrating a processing configuration example of a telephone call analysis server in a second exemplary embodiment.

FIG. 6 is a flowchart illustrating an operation example of a telephone call analysis server in a third exemplary embodiment.

### DESCRIPTION OF EMBODIMENTS

Exemplary embodiments of the present invention will now be described. Each exemplary embodiment to be described below is merely illustrative and the present invention is not limited to a configuration of the each exemplary embodiment described below.

A dissatisfying conversation determination device according to the present exemplary embodiment includes a data acquisition unit, an extraction unit, a change detection unit, and a dissatisfaction determination unit. The data acquisition unit acquires a plurality of word data and a plurality of phonation time data representing a phonation time of each word by a target conversation participant, the data are extracted from voice of the target conversation participant in a target conversation. The extraction unit extracts a plurality of specific word data each capable of configuring a polite expression or an impolite expression from the plurality of word data acquired by the data acquisition unit. The change detection unit detects a point of change from the polite expression to the impolite expression by the target conversation participant in the target conversation based on the plurality of specific word data extracted by the extraction unit and the plurality of phonation time data regarding the plurality of specific word data. The dissatisfaction determination unit determines whether the target conversation is a dissatisfying conversation by the target conversation participant based on a detection result of the point of change by the change detection unit.

A dissatisfying conversation determination method according to the present exemplary embodiment is performed by at least one computer and includes processing to acquire the plurality of word data and the plurality of phonation time data representing a phonation time of each word by the target conversation participant, the data are extracted from voice of the target conversation participant in the target conversation. Further, this dissatisfying conversation determination method includes processing to extract the plurality of specific word data each capable of configuring the polite expression or the impolite expression from the plurality of acquired word data. Further, this dissatisfying conversation determination method includes processing to detect the point of change from the polite expression to the impolite expression by the target conversation participant in the target conversation based on the plurality of extracted specific word data and the plurality of phonation time data regarding the plurality of specific word data. Further, this dissatisfying conversation determination method includes processing to determine whether the target conversation is the dissatisfying conversation by the target conversation participant based on the detection result of the point of change.

The target conversation represents a conversation to be an analysis target. The conversation represents that at least two speakers talk through an expression of intention by language utterances or the like. The conversation includes not only form in which conversation participants directly talk as seen at a teller window of bank, a cash register of a shop, and the like but also form in which conversation participants distantly located talk as seen in a telephone call using call devices, a video-conference, and the like. In the present exemplary embodiment, content or form of the target conversation is not limited, but as the target conversation, a public conversation is more desirable than a private conversation such as a conversation between friends and the like. The word data extracted from voice of the target conversation participant represents data obtained by expressing as a text, for example, words (nouns, verbs, postpositional words, and the like) included in the voice of the target conversation participant.

In the present exemplary embodiment, the plurality of word data and the plurality of phonation time data extracted from voice of the target conversation participant are acquired, and the plurality of specific word data are extracted from the plurality of word data. The specific word represents a word capable of configuring the polite expression or the impolite expression among the words and includes, for example, Japanese language: “desu (is)”, “masu”, “yo”, “wayo”, “anata (you)”, and “anta (you)”. Here, “impolite” is used in a broad sense representing “being not polite” such as rudeness and roughness.

The present inventors have found following things. That is, in a public place, specifically, many conversation participants (customers and the like) use polite language substantially as a whole and in a first half of a conversation, i.e., at the time of conveying a requirement of the conversation participant him-/her-self, normal utterances tend to be performed. And when having felt dissatisfaction in such a manner that his/her expectations have been disappointed or response contents of another conversation person are wrong, the conversation participant expresses dissatisfaction. As a result, when having felt dissatisfaction, even the conversation participant using polite language as a whole temporally exhibits a decrease in the degree of language politeness (becomes impolite). For example, in a telephone call of a contact center, when having felt dissatisfaction, a customer normally saying that “the PC won't start” expresses that “the PC does not start even after many trials”. Further, in the conversation at the teller window of the bank, when having felt dissatisfaction, a customer normally saying that “I would like to make this payment” changes such the expression to an expression that “why is this teller window unable to do it?”

Based on such findings, the present inventors focused attention to a change in politeness of utterances and then have acquired an idea in which this point of change in a conversation is a point of expression of dissatisfaction of a conversation participant, and a conversation where a point of expression of dissatisfaction exists is likely to be a dissatisfying conversation where the conversation participant feels dissatisfaction.

Therefore, in the present exemplary embodiment, using the plurality of specific word data and the plurality of phonation time data regarding these extracted as described above, a point of change from the polite expression to the impolite expression by the target conversation participant in a target conversation is detected. The detected point of change is equivalent to a point of expression of dissatisfaction of the target conversation participant in the target conversation. This point of change is information capable of identifying, for example, a certain point of time (or a certain part) in the target conversation and is represented by, for example, time. In the present exemplary embodiment, the point of change from the polite expression to the impolite expression is detected as the point of expression of dissatisfaction of the target conversation participant based on the findings regarding characteristics (tendencies) of conversation participants in conversations as described above, and whether the target conversation is the dissatisfying conversation by the target conversation participant is determined based on the detection result of the point of change (the point of dissatisfaction expression).

The point of change detected in the present exemplary embodiment may be used as a reference for determining a target interval to analyze on dissatisfaction by the target conversation participant. The reason is that at the point of change from the polite expression to the impolite expression, i.e., in voice of each conversation participant in the vicinity of the point of expression of dissatisfaction, information regarding dissatisfaction by the target conversation participant such as a cause for the dissatisfaction and a dissatisfaction degree is likely to be included. Therefore, in the present exemplary embodiment, an interval having a predetermined width of the target conversation in which the point of change is designated as an end may be determined as the target to analyze on dissatisfaction by the target conversation participant. When the determined interval of the analysis target is analyzed, information such as a cause for attracting dissatisfaction by the target conversation participant becomes extractable. In other words, in the present exemplary embodiment, by processing based on characteristics (tendencies) of conversation participants in conversations, it is possible to not only extract the conversation where conversation participants have felt dissatisfaction, but also appropriately identify an intra-conversation analysis part regarding dissatisfaction by the target conversation participant.

The exemplary embodiment will be described in more detail below. A first exemplary embodiment and a second exemplary embodiment will be exemplified as detailed exemplary embodiments. Each following exemplary embodiment is an example in which the dissatisfying conversation determination device and the dissatisfying conversation determination method described above are applied to the contact center system. The dissatisfying conversation determination device and the dissatisfying conversation determination method are not limited to applications to a contact center system handling telephone call data and are applicable to various aspects handling conversation data. These are applicable, for example, to an in-house telephone call management system other than the contact center as well as to call terminals such as PC (Personal Computer), fixed-line phone, mobile phone, tablet terminal, smartphone, and the like individually possessed. As the conversation data, for example, data representing a conversation between a person in charge and a customer at a teller window of a bank or a cash register of a shop may be exemplified. Hereinafter, the telephone call represents a call in an interval from a call connection to a call disconnection between call devices each possessed by a given caller and another given caller.

### First Exemplary Embodiment

### System Configuration

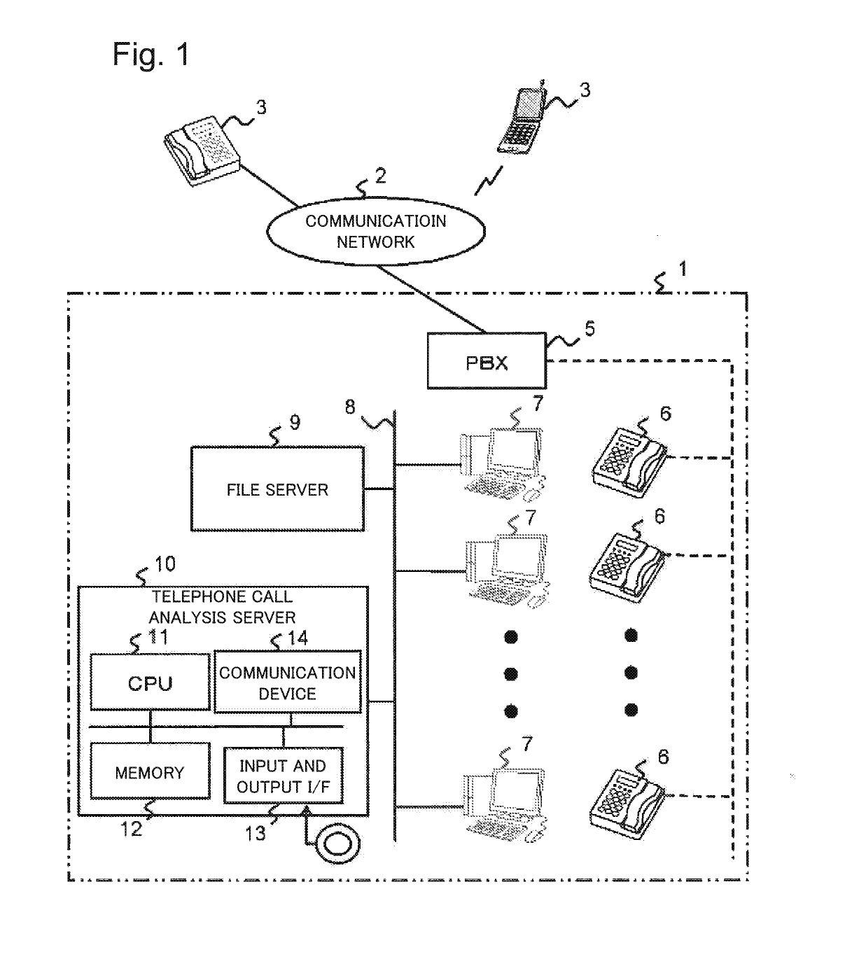

FIG. 1 is a conceptual diagram illustrating a configuration example of a contact center system 1 in the first exemplary embodiment. The contact center system 1 in the first exemplary embodiment includes a switching system (PBX) 5, a plurality of operator phones 6, a plurality of operator terminals 7, a file server 9, and a telephone call analysis server 10. The telephone call analysis server 10 includes the configuration equivalent to the dissatisfying conversation determination device in the exemplary embodiment described above. In the first exemplary embodiment, a customer is equivalent to the target conversation participant.

The switching system 5 is communicably connected to a call terminal (customer phone) 3 such as PC, fixed-line phone, mobile phone, tablet terminal, smartphone, and the like via a communication network 2. The communication network 2 is a public network such as an Internet and a PSTN (Public Switched Telephone Network), a wireless communication network, or the like. The switching system 5 is connected to each of the operator phones 6 used by respective operators in the contact center. The switching system 5 receives a call from a customer and then connects the call to the operator phone 6 of the operator responding to the call.

The operators each use a corresponding operator terminal 7. Each operator terminal 7 is a general computer such as a PC and the like connected to a communication network 8 (LAN (Local Area Network) or the like) inside the contact center system 1. Each operator terminal 7 records, for example, voice data of a customer and voice data of an operator separately in a telephone call between the customer and the operator. Each operator terminal 7 may also record voice data of the customer while the call is held. The voice data of the customer and the voice data of the operator may be generated by being separated from a mixed state using predetermined voice processing. In the present exemplary embodiment, a recording method for such voice data or a recording subject is not limited. The respective voice data may be generated using another device (not illustrated) other than the operator terminal 7.

The file server 9 is implemented by a general server computer. The file server 9 stores telephone call data of each telephone call between the customer and the operator together with identification information of the telephone call. The telephone call data includes a pair of voice data of the customer and voice data of the operator. The file server 9 acquires the voice data of the customer and the voice data of the operator from another device (each operator terminal 7 or the like) that records respective voices of the customer and the operator.

The telephone call analysis server 10 performs analysis on dissatisfaction of the customer for each telephone call data stored on the file server 9.

As illustrated in FIG. 1, the telephone call analysis server 10 includes, as a hardware configuration, a CPU (Central Processing Unit) 11, a memory 12, an input and output interface (I/F) 13, and a communication device 14. The memory 12 is a RAM (Random Access Memory), a ROM (Read Only Memory), a hard disk, a portable storage medium, or the like. The input and output I/F 13 is connected to a device such as a keyboard, a mouse, and the like for receiving input of user operation and to a device such as a display device, a printer, and the like for providing information to the user. The communication device 14 communicates with the file server 9 and others via the communication network 8. The hardware configuration of the telephone call analysis server 10 is not limited.

(Processing Configuration)

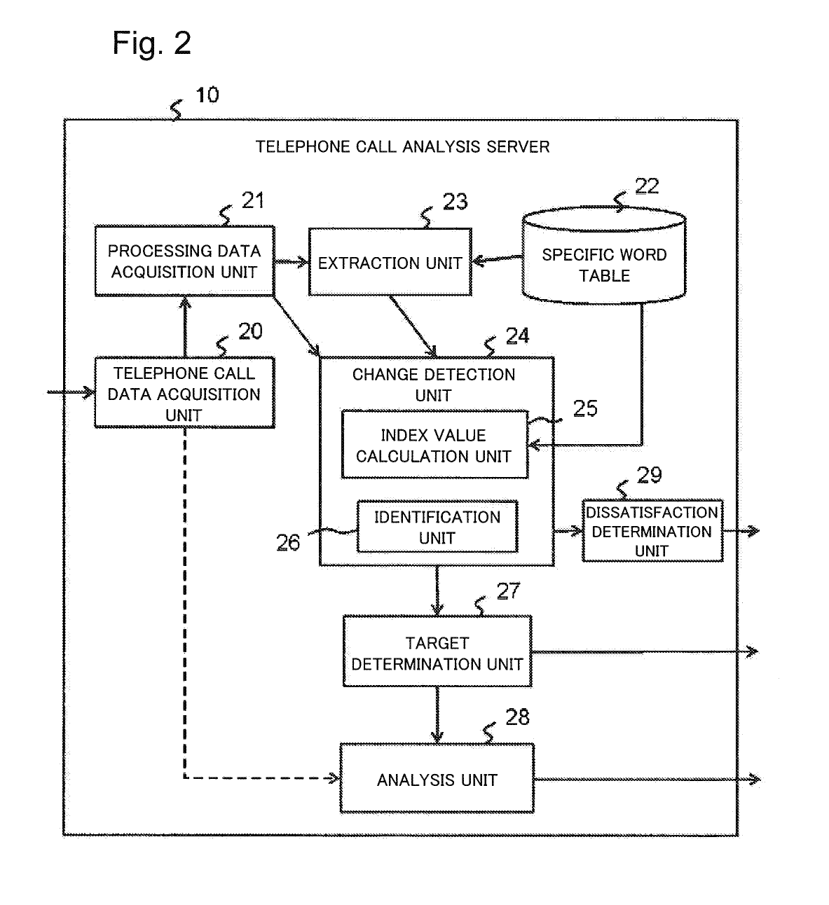

FIG. 2 is a diagram conceptually illustrating a processing configuration example of the telephone call analysis server 10 in the first exemplary embodiment. The telephone call analysis server 10 in the first exemplary embodiment includes a telephone call data acquisition unit 20, a processing data acquisition unit 21, a specific word table 22, an extraction unit 23, a change detection unit 24, a target determination unit 27, an analysis unit 28, and a dissatisfaction determination unit 29. Each of the processing units is implemented, for example, by executing a program stored on the memory 12 using the CPU 11. The program may be installed from a portable recording medium such as a CD (Compact Disc), a memory card, and the like or from another computer on a network via the input and output I/F 13 and stored on the memory 12.

The telephone call data acquisition unit 20 acquires the telephone call data of a telephone call to be an analysis target together with the identification information of the telephone call. The telephone call data may be acquired through communications between the telephone call analysis server 10 and the file server 9 or via the portable recording medium.

From the telephone call data acquired by the telephone call data acquisition unit 20, the processing data acquisition unit 21 acquires a plurality of word data and a plurality of phonation time data representing a phonation time of each word by a customer, the data are extracted from voice data of the customer included in the telephone call data. The processing data acquisition unit 21, for example, forms the voice data of the customer as a text using voice recognition processing and acquires the phonation time data for each word string and each word. The voice recognition processing, for example, forms voice data as a text and also generates phonation time data representing the phonation time of character included in the text data. A well-known method may be used for such the voice recognition processing and therefore, description thereof is omitted here. The processing data acquisition unit 21 acquires the phonation time data for the respective word data based on the phonation time data generated by the voice recognition processing in such a manner.

In case that it is difficult to acquire the phonation time information for each word in the voice recognition processing, the processing data acquisition unit 21 may acquire the phonation time data as described below. The processing data acquisition unit 21 detects an utterance interval of the customer based on the voice data of the customer. The processing data acquisition unit 21 detects, for example, an interval where sound volume having at least a predetermined value continues in a voice waveform represented by the voice data of the customer, as the utterance interval. The detection of the utterance interval represents that an interval corresponding to one utterance of the customer in the voice data is detected, whereby a beginning time and an end time of the interval are acquired. When the voice recognition processing forms the voice data into the text, the processing data acquisition unit 21 acquires a relationship between each the utterance interval and the text data corresponding to the utterance represented by the utterance interval and then, based on this relationship, acquires a relationship between each word data obtained by morphological analysis and each utterance interval. Based on the beginning time and the end time of the utterance interval and an order of word data in the utterance interval, the processing data acquisition unit 21 calculates each phonation time data corresponding to each word data. When, for example, six words are present in the utterance interval where the beginning time is 5 minutes and 30 seconds and the end time is 5 minutes and 36 seconds, the phonation time data of a second word is calculated as 5 minutes and 31 seconds (=5 minutes and 30 seconds+(2−1)×6 seconds/6), and the phonation time data of a sixth word is calculated as 5 minutes and 35 seconds (=5 minutes and 30 seconds+(6−1)×6 seconds/6). The processing data acquisition unit 21 may take into account the number of characters of each word data together to calculate each the phonation time data.

The specific word table 22 holds the plurality of specific word data each capable of configuring the polite expression or the impolite expression and a plurality of word index values representing politeness or impoliteness for each of the plurality of specific words. The word index value is set, for example, as a lager value with an increase in the politeness (decrease in the impoliteness) represented by the specific word and as a smaller value with a decrease in the politeness (an increase in the impoliteness) represented by the specific word. The word index value may represent any one of politeness, impoliteness, and neither thereof. In this case, the word index value of the specific word representing politeness is set as “+1,” the word index value of the specific word representing impoliteness is set as “−1,” and the word index value of the specific word representing neither thereof is set as “0”. In the present exemplary embodiment, the specific word data and the word index value stored in the specific word table 22 is not limited. As the specific word data and the word index values stored in the specific word table 22, well-known word information (part-of-speech information) and politeness information are usable and therefore, description thereof is omitted here. This specific word table is disclosed also in PTL 2 described above.

The extraction unit 23 extracts a plurality of specific word data registered in the specific word table 22 from a plurality of word data acquired by the processing data acquisition unit 21.

The change detection unit 24 detects the point of change from the polite expression to the impolite expression of the customer in the target telephone call based on the plurality of specific word data extracted by the extraction unit 23 and the plurality of phonation time data regarding the plurality of specific word data. As illustrated in FIG. 2, the change detection unit 24 includes an index value calculate unit 25 and an identification unit 26. The change detection unit 24 detects the point of change using these processing units.

Using the specific word data included in a predetermined range among the plurality of specific word data arranged in a chronological order based on the plurality of phonation time data as a processing unit, the index value calculation unit 25 calculates an index value representing the politeness or the impoliteness for each the processing unit specified by sequentially sliding the predetermined range in the chronological order at a predetermined width. The predetermined range for determining the processing unit is specified using, for example, the number of the specific word data, a time period, or the number of the utterance intervals. The predetermined width equivalent to the slide width of the predetermined range is also specified in the same manner, using, for example, the number of the specific word data, the time period, or the number of the utterance intervals. The predetermined range and the predetermined width are held by the index value calculation unit 25 so as to be adjustable in advance.

It is desirable to determine the predetermined width and the predetermined range based on a necessary balance between a granularity of the point of change and a processing load. In case that the predetermined width is set to be small and the predetermined range is set to be narrow, the number of the processing units increases. An increase in the number of the processing units makes it possible to increase the detection granularity of the point of change, but in association therewith, the processing load is increased. On the other hand, in case that the predetermined width is set to be large and the predetermined range is set to be wide, the number of the processing units decreases. A decrease in the number of the processing units decreases the detection granularity of the point of change, but in association therewith, the processing load is reduced.

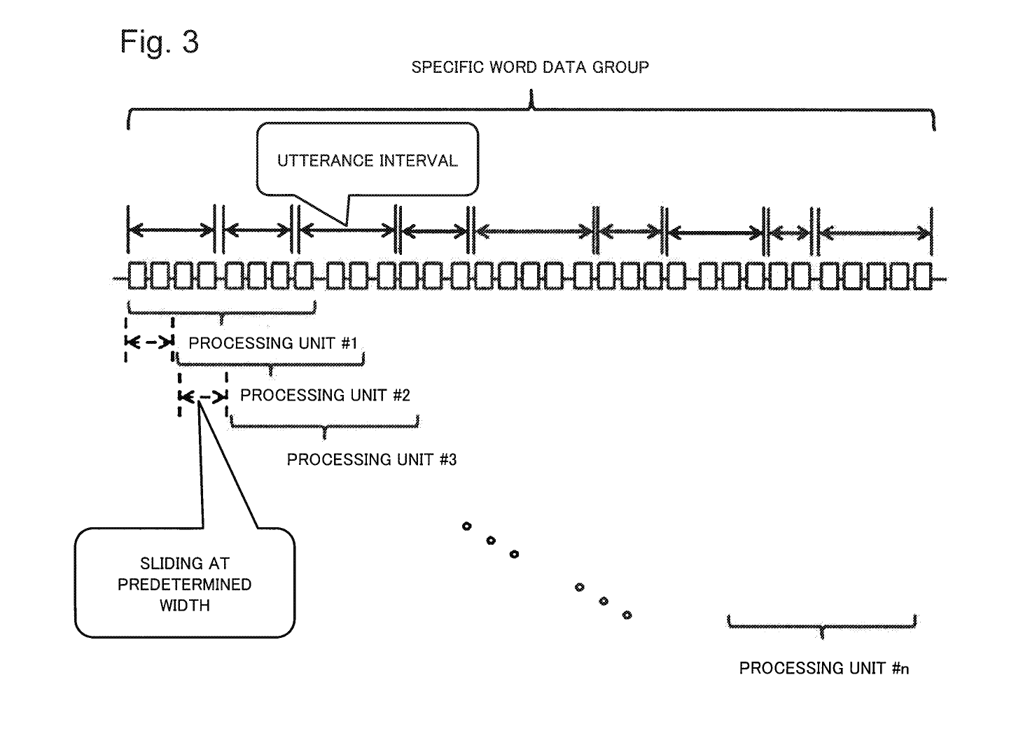

FIG. 3 is a diagram conceptually illustrating a processing unit according to the index value calculation unit 25. FIG. 3 illustrates an example in which the predetermined range and the predetermined width are specified using the number of the specific word data. In the example of FIG. 3, the predetermined range is set to be the specific word data number (=8) and the predetermined width is set to be the specific word data number (=2).

The index value calculation unit 25 extracts each of the word index values regarding respective the specific word data included in each processing unit and calculates a total value of the word index values for the each processing unit as an index value of the each processing unit. According to the example of FIG. 3, the index value calculation unit 25 calculates the total value of the word index values with respect to each of a processing unit #1, a processing unit #2, and a processing unit #3.

The identification unit 26 identifies the adjacent processing units in which a difference of the index values between the processing units adjacent to each other exceeds a predetermined threshold. In the first exemplary embodiment, the difference of the index values is obtained based on an absolute value of a subtraction result obtained by subtracting the index value of the anterior processing unit from the index value of the posterior processing unit. This processing of the identification unit 26 detects the change from the polite expression to the impolite expression. Specifically, the identification unit 26 identifies the adjacent processing units in which the value obtained by subtracting the index value of the anterior processing unit from the index value of the posterior processing unit is a negative value and also the absolute value of the subtracted value exceeds the predetermined threshold. This processing example of the identification unit 26 is an example in which the word index value is set the larger value as the politeness represented by the specific word increases (the impoliteness decreases) and is set the smaller value as the politeness represented by the specific word decreases (the impoliteness increases). The predetermined threshold is determined, for example, with a validation based on the voice data of customers in the contact center and held in advance by the identification unit 26 so as to be adjustable.

The change detection unit 24 determines the point of change based on the adjacent processing units identified by the identification unit 26. The change detection unit 24 determines, for example, the phonation time of the specific word that is included in the posterior of the adjacent processing units identified by the identification unit 26 and is not included in the anterior, as the point of change. The reason is that there is a high possibility in which the specific word having been included in the posterior processing unit by sliding processing unit at the predetermined width has caused the difference of the index values between processing units exceeding the predetermined threshold. In case that there are the plurality of specific word that is included in the posterior processing unit and is not included in the anterior processing unit, the change detection unit 24 may determine the phonation time of the specific word next to the last specific word of the anterior processing unit, as the point of change.

The dissatisfaction determination unit 29 determines whether the target conversation is a dissatisfying conversation by the target conversation participant, based on the detection result of the point of change obtained by the change detection unit 24. Specifically, in case that the point of change from the polite expression to the impolite expression of the customer is detected from target telephone call data, the dissatisfaction determination unit 29 determines the target telephone call as the dissatisfying telephone call, and in case that the point of change is not detected, the dissatisfaction determination unit 29 determines the target telephone call not to be the dissatisfying telephone call. The dissatisfaction determination unit 29 may output the identification information of the target telephone call determined as the dissatisfying telephone call to a display unit or another output device via the input and output I/F 13. The present exemplary embodiment, a specific form of the output is not limited.

The target determination unit 27 determines the target interval to analyze the dissatisfaction of the customer, the target interval has a predetermined width of the target telephone call and is designated the point of change detected by the change detection unit 24 as an end. The predetermined width represents a range during the target telephone call extracted the voice data or the text data corresponding to the voice data necessary to analyze a cause and the like for the dissatisfying expression of the customer. This predetermined width is specified using, for example, the number of utterance intervals or a time period. The predetermined width is determined, for example, by being validated based on the voice data of customer in the contact center and held in advance by the target determination unit 27 so as to be adjustable.

It is possible that the target determination unit 27 generates data representing the determined analysis target interval (e.g., data representing the beginning time and the end time of the interval) and then outputs the determination result to a display unit or another output device via the input and output I/F 13. The present exemplary embodiment, the specific form of the data output is not limited.

The analysis unit 28 analyzes dissatisfaction of the customer in the target telephone call based on the voice data of the customer and the operator or the text data extracted from the voice data corresponding to the analysis target interval determined by the target determination unit 27. As the analysis on dissatisfaction, for example, a cause for the dissatisfying expression or a dissatisfaction degree is analyzed. As a specific analysis method according to the analysis unit 28, a well-known method such as a voice recognition technique, an emotion recognition technique, and the like is usable and therefore, description thereof is omitted here. The present exemplary embodiment, the specific analysis method according to the analysis unit 28 is not limited.

It is possible that the analysis unit 28 generates data representing an analysis result and outputs the determination result to a display unit or another output device via the input and output I/F 13. The present exemplary embodiment, the specific form of this data output is not limited.

### Operation Example

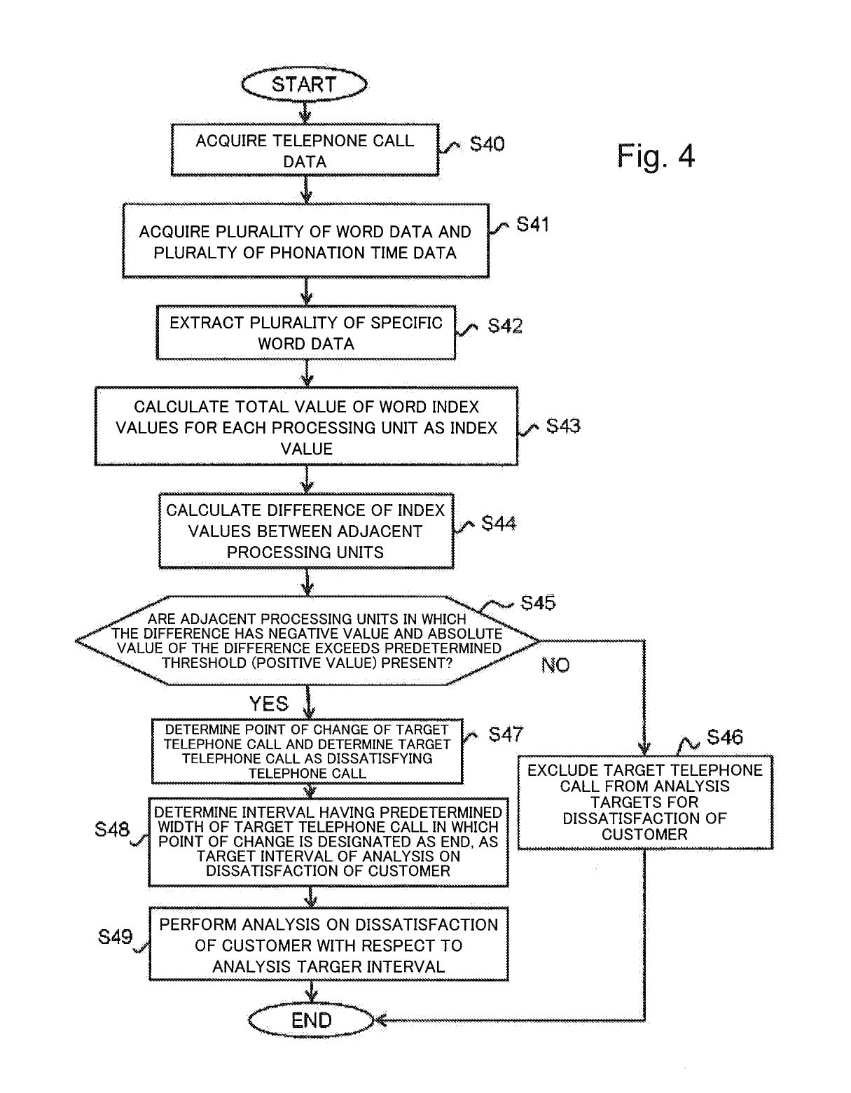

The dissatisfying conversation determination method in the first exemplary embodiment will be described below with reference to FIG. 4. FIG. 4 is a flowchart illustrating an operation example of the telephone call analysis server 10 in the first exemplary embodiment.

The telephone call analysis server 10 acquires telephone the call data (S40). In the first exemplary embodiment, the telephone call analysis server 10 acquires the telephone call data to be an analysis target from a plurality of telephone call data stored on the file server 9.

From the telephone call data unit acquired in Step S40, the telephone call analysis server 10 acquires the plurality of word data and the plurality of phonation time data representing the phonation time of each word by a customer, the data being extracted from the voice data of the customer included in the telephone call data unit (S41).

The telephone call analysis server 10 extracts the plurality of specific word data registered in the specific word table 22 from the plurality of word data regarding the voice of the customer (S42). As described above, the specific word table 22 holds the plurality of specific word data capable of configuring the polite expression or the impolite expression and the plurality of word index values representing the politeness or the impoliteness for each of the plurality of specific words. In step S42, the plurality of specific word data capable of configuring the polite expression or the impolite expression and the phonation time data of each specific word data, with respect to the voice of the customer, are acquired.

For each processing unit based on the plurality of specific word data extracted in step S42, the telephone call analysis server 10 calculates the total value of the word index values as the index value of the each processing unit (S43). The telephone call analysis server 10 extracts the word index value of each specific word data from the specific word table 22.

The telephone call analysis server 10 calculates the difference of the index values for each set of adjacent processing units (S44). Specifically, the telephone call analysis server 10 subtracts the index value of the anterior processing unit from the index value of the posterior processing unit to calculate the difference of the index values.

The telephone call analysis server 10 attempts to identify the adjacent processing units in which the difference of the index values has the negative value and the absolute value of the difference exceeds the predetermined threshold (the positive value) (S45). When having failed to identify the adjacent processing units (S45; NO), the telephone call analysis server 10 excludes the target telephone call from analysis target for the dissatisfaction of the customer (S46).

On the other hand, when having succeeded in identifying the adjacent processing units (S45; YES), the telephone call analysis server 10 determines the point of change in the target telephone call based on the identified adjacent processing units (S47). Further, when the point of change has been detected from the target telephone call data, the telephone call analysis server 10 determines the target telephone call as the dissatisfying telephone call (S47).

The telephone call analysis server 10 determines the interval that has the predetermined width of the target telephone call and is designated the determined point of change as an end, as the target interval for analysis on the dissatisfaction of the customer (S48). The telephone call analysis server 10 may generate the data representing the determined target interval and output this data.

The telephone call analysis server 10 analyzes the dissatisfaction of the customer in the target telephone call, using the voice data of the determined analysis target interval or text data thereof (S49). The telephone call analysis server 10 may generate data representing the determination result and output this data.

### Operations and Effects of the First Exemplary Embodiment

As described above, in the first exemplary embodiment, the plurality of specific word data each capable of configuring the polite expression or the impolite expression are extracted from the voice data of the customer in the target telephone call, the word index values of the extracted specific word data are extracted from the specific word table 22, and the total value of the word index values for each processing unit based on the plurality of specific word data is calculated as the index value of the each processing unit. Then, the difference of the index values of the adjacent processing units is calculated, the adjacent processing units in which the difference has the negative value and the absolute value of the difference exceeds the predetermined threshold are identified, and the point of change of the target telephone call is detected based on the identified adjacent processing units.

The point of change is detected based on the index value for each predetermined range with respect to the specific word data in such a manner and therefore, according to the first exemplary embodiment, it is possible to accurately detect a statistical change from the polite expression to the impolite expression independently of an impolite word erroneously uttered occasionally. Further, according to the first exemplary embodiment, the telephone call in which the point of change from the polite expression to the impolite expression is detected is determined as the dissatisfying telephone call and therefore, it is possible to prevent the telephone call of the customer using rude language on average from being erroneously determined as the dissatisfying telephone call. Thus, it is possible to prevent the entire telephone call of the customer using rude language on average from being determined as the dissatisfaction analysis target of the customer and therefore, to appropriately identify an intra-telephone call analysis part regarding dissatisfaction of a caller.

Further, the first exemplary embodiment, the interval having the predetermined width of the target telephone call in which the point of change determined as described above is designated as the end is determined as the target for analysis on the dissatisfaction of the customer and analyzes the dissatisfaction of the customer using the voice data of the operator and the customer, text data thereof, or the like in this analysis target interval. In the first exemplary embodiment, the telephone call data of the interval having the predetermined range prior to the point of expression of the dissatisfaction of the customer accurately detected in this manner is used and therefore, it is possible to limit the analysis target and also to intensively analyze a part regarding the dissatisfaction expression, resulting in accuracy enhancement of dissatisfaction analysis.

### Second Exemplary Embodiment

In case that the change from the polite expression to the impolite expression is present in the telephone call, there may be mixed a combination of the polite expression and the impolite expression having the same meaning as seen in a combination of Japanese language: “ . . . nandesu. (is)” and “ . . . nandayo. (is)”, a combination of Japanese language: “doshite (why) . . . desuka?” and “nande (why) . . . nano?” and a combination of Japanese language: “anata (you)”, “anta (you)” and “omae (you)”. Conversely, in case that such the combination of both expressions having the same meaning is present in the telephone call, it is highly possible that the change from the polite expression to the impolite expression occurs in the telephone call, resulting in a high possibility in which a customer expresses dissatisfaction in the telephone call.

Therefore, in a second exemplary embodiment, using combination information representing combination of the specific word of the polite expression and the specific word of the impolite expression having the same meaning as described above, the index value of respective processing units are calculated. A contact center system 1 in the second exemplary embodiment will be described by focusing on matters different from those in the first exemplary embodiment 1. In the following description, the same matters as in the first exemplary embodiment will be omitted as appropriate.

(Processing Configuration)

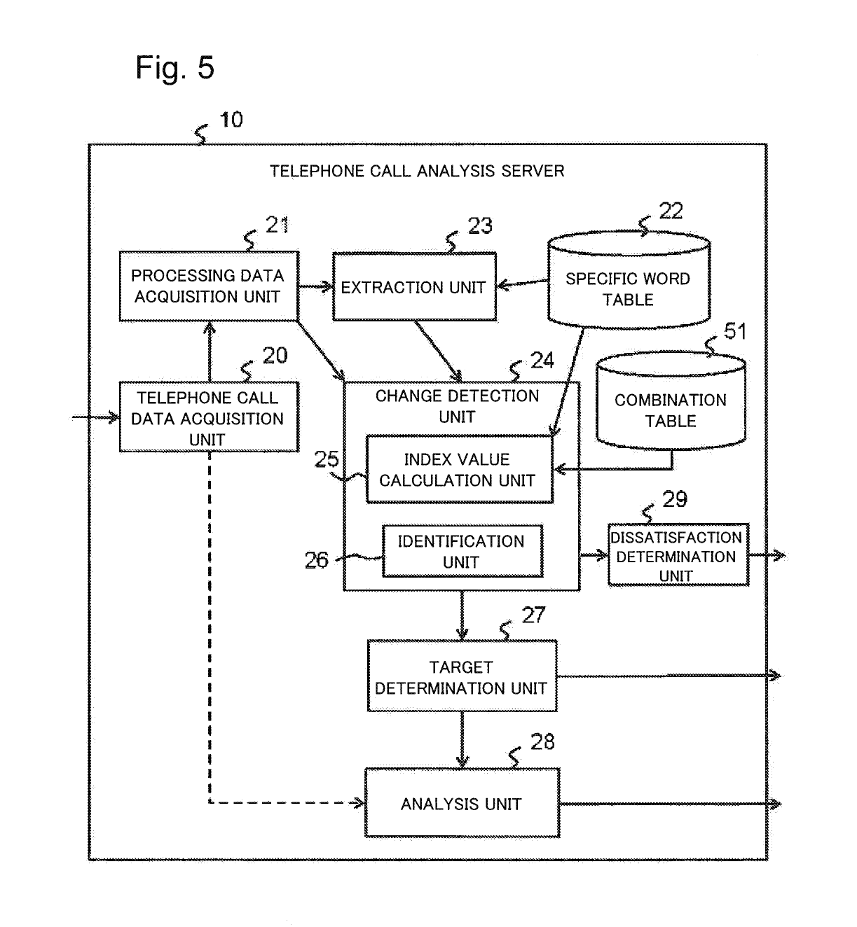

FIG. 5 is a diagram conceptually illustrating a processing configuration example of the telephone call analysis server 10 in the second exemplary embodiment. The telephone call analysis server 10 in the second exemplary embodiment further includes a combination table 51 in addition to the configurations of the first exemplary embodiment.

The combination table 51 holds the combination information representing the combination of the specific word of the polite expression and the specific word of the impolite expression having the same meaning among the plurality of specific words each capable of configuring the polite expression or the impolite expression. The combination information includes a special word index value and a normal word index value, the special word index value is the word index value that is applied when both the specific word of the polite expression and the specific word of the impolite expression are included in the plurality of specific word data extracted by the extraction unit 23, the normal word index value is the word index value that is applied when only any one of these words is included in the plurality of specific word data, with respect to each combination.

The special word index value is set so that an absolute value thereof is larger than an absolute value of the normal word index value. The reason is that the combination of the specific word of the polite expression and the specific word of the impolite expression having the same meaning markedly representing the change from the polite expression to the impolite expression dominantly determines an index value of each processing unit. Further, the special word index value includes the special word index value (e.g., positive value) for the specific word of the polite expression and the special word index value (e.g., negative value) for the specific word of the impolite expression. On the other hand, in the same manner, the normal word index value includes the normal word index value (e.g., positive value) for the specific word of the polite expression and the normal word index value (e.g., negative value) for the specific word of the impolite expression. The normal word index value is desirably the same value as the word index value of specific word data stored in the specific word table 22.

However, the combination information may include both the normal word index value and a weighting value, with respect to each combination. In this case, the special word index value is calculated by multiplying the normal word index value and the weighting value.

The index value calculation unit 25 acquires the combination information from the combination table 51 and calculates each of index values of respective processing units by treating a combination in which both the specific word of the polite expression and the specific word of the impolite expression among the plurality of combinations included in the acquired combination information are included in the plurality of specific word data extracted by the extraction unit 23, separately from other specific word data. Specifically, the index value calculation unit 25 confirms whether both the specific word of the polite expression and the specific word of the impolite expression are included in the plurality of specific word data, with respect to each combination indicated by the combination information. When both words in the combination are included, the index value calculation unit 25 sets the special word index value (for the polite expression and the impolite expression) for the word index value of each specific word data in the combination. On the other hand, when any one of the words in the combination is included, the index value calculation unit 25 sets the normal word index value (for the polite expression or the impolite expression) for the word index value of the specific word data.

The index value calculation unit 25 sets the word index value extracted from the specific word table 22 for the specific word data unit that is not included in the combination information among the plurality of specific word data extracted by the extraction unit 23, in the same manner as in the first exemplary embodiment. The index value calculation unit 25 calculates each of index values of respective processing units using the word index value set for each specific word data in this manner.

### Operation Example

A dissatisfying conversation determination method in the second exemplary embodiment will be described with reference to FIG. 4. In the second exemplary embodiment, the processing in step S43 differs from the first exemplary embodiment. In the second exemplary embodiment, prior to calculating the total value of the word index values of each processing unit, the word index value of each specific word data included in the each processing unit is determined using the word index value stored in the specific word table 22 as well as the special word index value and the normal word index value stored in the combination table 51. A method for determining the word index value of each specific word data is as described in the index value calculation unit 25.

### Operations and Effects of the Second Exemplary Embodiment

As described above, in the second exemplary embodiment, each of the index values of respective processing units is calculated using the combination information representing combination of the specific word of the polite expression and the specific word of the impolite expression having the same meaning. For the combination of the specific word of the polite expression and the specific word of the impolite expression having the same meaning, the word index value having the absolute value larger than those of other specific word data is set.

In this manner, the index value of each processing unit is calculated so as to cause each combination of the specific word of the polite expression and the specific word of the impolite expression having the same meaning to be dominant and therefore, in the second exemplary embodiment, it is possible to precisely detect the change from the polite expression to the impolite expression in the telephone call independently of the impolite expression having been abruptly used by the customer without any relation to dissatisfaction.

### Third Exemplary Embodiment

In the above exemplary embodiments, the interval having the predetermined width of the target telephone call in which the detected point of change is designated as the end is determined as the target interval for analysis on the dissatisfaction of the customer. This target interval is the interval prior to the point of expression of the dissatisfaction of the customer and therefore, is likely to include a cause for attracting the dissatisfaction of the customer. However, analysis on the dissatisfaction of the customer includes analysis of a level of dissatisfaction (a dissatisfaction degree) of the customer in addition to cause analysis. It is highly possible to represent such the dissatisfaction degree of the customer as the telephone call interval expressing dissatisfaction by the customer.

Therefore, in the third exemplary embodiment, a point of return from the impolite expression to the polite expression in the target telephone call is further detected. And, an interval of the target telephone call where the point of change is designated as the beginning and the point of return is designated as the end is added further to the analysis target interval. In the third exemplary embodiment, this added analysis target interval is set as the interval where the customer expresses dissatisfaction. The reason is that since the point of return is a point of change from the impolite expression to the polite expression, a level of dissatisfaction of the customer is conceivable to decrease and then it is possible to estimate the interval from the point of expression (the point of change) of the dissatisfaction to the point of return as a state where the customer feels dissatisfaction.

A contact center system 1 in the third exemplary embodiment will be described by focusing on matters different from those in the first exemplary embodiment and the second exemplary embodiment. In the following description, the same matters as in the first exemplary embodiment and the second exemplary embodiment will be omitted as appropriate.

(Processing Configuration)

The processing configuration of the telephone call analysis server 10 in the third exemplary embodiment is similar to those of the first exemplary embodiment or the second exemplary embodiment, as illustrated in FIG. 2 or FIG. 5, respectively. However, processing contents of processing units described below are different from those of the first exemplary embodiment and the second exemplary embodiment.

The change detection unit 24 further detects the point of return from the impolite expression to the polite expression in the target telephone call of the customer, based on the plurality of specific word data extracted by the extraction unit 23 and the plurality of phonation time data regarding the plurality of specific word data. The change detection unit 24 determines the point of return based on the adjacent processing units identified by the identification unit 26. A method for determining the point of return from the identified adjacent processing units is the same as the method for determining the point of change and therefore, description thereof is omitted here.

The identification unit 26 identifies the following adjacent processing units in addition to the processing in the above exemplary embodiments. The identification unit 26 identifies the adjacent processing units in which a value obtained by subtracting the index value of the anterior processing unit from the index value of the posterior processing unit is a positive value and also the subtracted value exceeds the predetermined threshold. This processing example of the identification unit 26 is also an example in which the word index value is set a larger value as the politeness increases (as the impoliteness decreases) represented by the specific word and is set a smaller value as the politeness decreases (as the impoliteness increases) represented by the specific word. As the predetermined threshold used in the identification unit 26 to determine the point of return, a predetermined threshold used to determine the point of change is usable or another predetermined threshold is usable. It is thought that it is difficult for the customer to completely return to normal feeling after expressing dissatisfaction and therefore, for example, the absolute value of the predetermined threshold for the point of return may be set to be smaller than the absolute value of the predetermined threshold for the point of change.

The target determination unit 27 further determines an interval of the target telephone call in which the point of change is designated as the beginning and the point of return is designated as the end, as the analysis target interval, in addition to the analysis target interval determined as described in the above exemplary embodiments. The target determination unit 27 may distinguishably determine the analysis target interval in which the point of change is determined as the end and the analysis target interval in which the point of change and the point of return are determined as the beginning and the end, respectively. Hereinafter, the former interval may be expressed as a cause analysis target interval and the latter interval may be expressed as a dissatisfaction degree analysis target interval. However, these expressions do not limit use of the former interval only for cause analysis or use of the latter interval only for dissatisfaction analysis. It is possible that a dissatisfaction degree is extracted based on the cause analysis target interval and a dissatisfaction cause is extracted based on the dissatisfaction degree analysis target interval, or another analysis result is obtained based on both intervals.

The analysis unit 28 analyzes the dissatisfaction of the customer in the target telephone call based on the voice data of the customer and the operator, the text data extracted from the voice data, or the like in the cause analysis target interval and the dissatisfaction degree analysis target interval determined by the target determination unit 27. The analysis unit 28 may apply different analysis processings each to the cause analysis target interval and the dissatisfaction degree analysis target interval.

### Operation Example

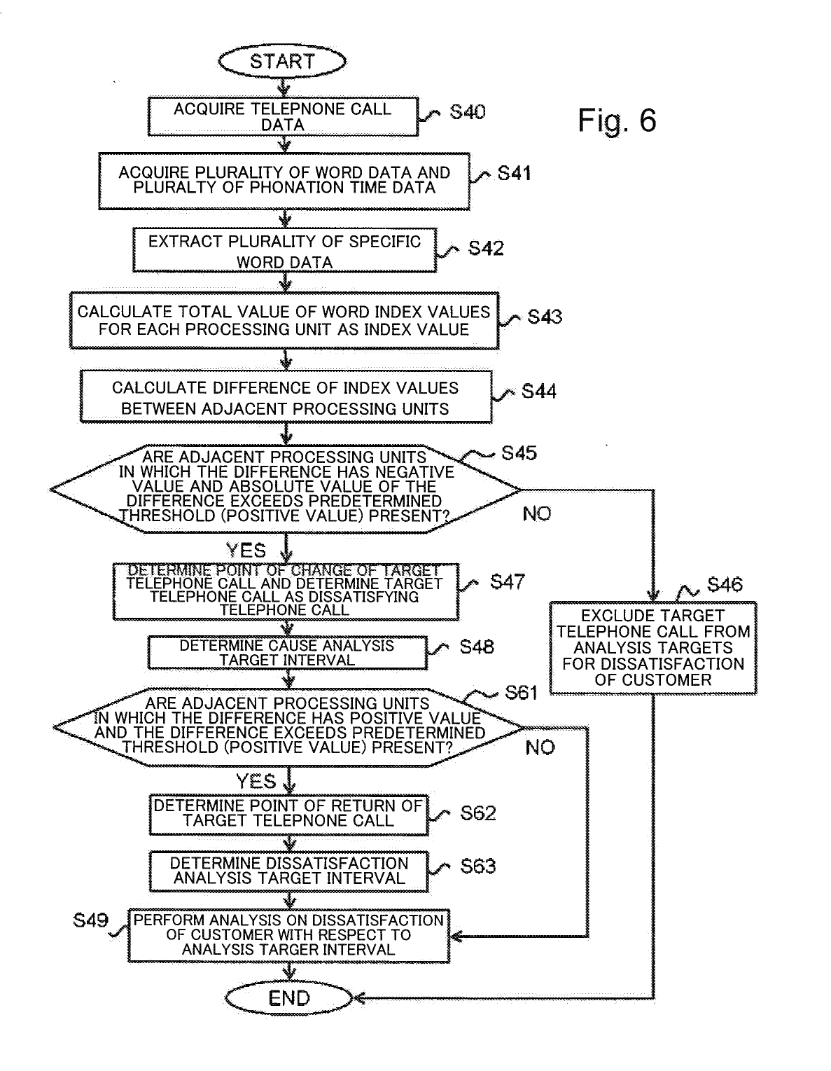

A dissatisfying conversation determination method in the third exemplary embodiment will be described with reference to FIG. 6. FIG. 6 is a flowchart illustrating an operation example of the telephone call analysis server 10 in the third exemplary embodiment. In the third exemplary embodiment, step S61 to step S63 are added to the steps of the first exemplary embodiment. In FIG. 6, each same step as in FIG. 4 is assigned with the same reference sign as in FIG. 4.

When determining, as the cause analysis target interval, the interval having the predetermined width of the target telephone call in which the point of change is designated as the end (S48), the telephone call analysis server 10 further attempts to identify the adjacent processing units in which a difference of the index values is a positive value and also the difference exceeds the predetermined threshold (the positive value) (S61). When having failed to identify the adjacent processing units (S61; NO), the telephone call analysis server 10 analyzes the dissatisfaction of the customer in the target telephone call using only the cause analysis target interval determined in step S48 (S49).

On the other hand, when having succeeded in identifying the adjacent processing units (S61; YES), the telephone call analysis server 10 determines the point of return in the target telephone call based on the identified adjacent processing units (S62).

The telephone call analysis server 10 determines, as a dissatisfaction degree analysis target interval, the interval having the predetermined width of the target telephone call in which the point of change determined in step S47 is designated as the beginning and the point of return determined in step S62 is designated as the end (S63). The telephone call analysis server 10 may generate the data representing the determined dissatisfaction degree analysis target interval and output this data.

In this case, the telephone call analysis server 10 analyzes the dissatisfaction of the customer in the target telephone call, using the voice data of the cause analysis target interval and the dissatisfaction degree analysis target interval or the text data thereof (S49).

### Operations and Effects of the Third Exemplary Embodiment

As described above, in the third exemplary embodiment, the point of return from the impolite expression to the polite expression is detected in addition to the point of change from the polite expression to the impolite expression, and the telephone call interval (the dissatisfaction degree analysis target interval) in which the point of change is designated as the beginning and the point of return thereof is designated as the end is determined, as the target interval for analyzing the dissatisfaction of the customer, in addition to the telephone call interval (the cause analysis target interval) having the predetermined width of the target telephone call in which the point of change is designated as the end.

The analysis target interval additionally determined in the third exemplary embodiment is likely to be a state where the customer is expressing dissatisfaction as describe above and therefore, in the third exemplary embodiment, it is possible to identify the telephone call interval suitable for analysis on the dissatisfaction of the customer or the like. In other words, in the third exemplary embodiment, it is possible to appropriately identify the target interval for every analysis on the dissatisfaction of the customer and as a result, to perform every analysis on the dissatisfaction of the customer using the identified telephone call interval.

### Modified Examples

In each of the exemplary embodiments, an example in which the telephone call analysis server 10 included the telephone call data acquisition unit 20, the processing data acquisition unit 21, and the analysis unit 28 is given, but each of these processing units may be implemented using another device. In this case, the telephone call analysis server 10 (equivalent to the data acquisition unit of the present invention) may operate as a dissatisfying conversation determination device and acquire the plurality of word data and the plurality of phonation time data each representing the phonation time of each word by the customer, the data being extracted from the voice data of the customer from the another device. Further, it is possible that the telephone call analysis server 10 does not have the specific word table 22 but acquires desired data from the specific word table 22 implemented on another device.

In each of the exemplary embodiments, the index value of each processing unit is obtained using the total of the word index values of the specific word data included in the each processing unit, but may be determined without using any word index values. In this case, it is possible that the specific word table 22 does not have the word index value of each specific word, but holds information representing the polite expression or the impolite expression with respect to the each specific word. Thereby, the index value calculation unit 25 may count the number of specific word data included in the each processing unit for each polite expression and each impolite expression and calculates the index value for the each processing unit based on a count number of the polite expressions and a count number of the impolite expressions in the each processing unit. For example, a ratio of the count number of the polite expressions and the count number of the impolite expressions may be designated as the index value for the each processing unit.

In the second exemplary embodiment, the telephone call analysis server 10 includes the specific word table 22 and the combination table 51, but the specific word table 22 may be excluded. In this case, the extraction unit 23 extracts the plurality of specific word data held in the combination table 51 from the plurality of word data acquired by the processing data acquisition unit 21. Further, the index value calculation unit 25 determines, as the word index value of each specific word data, any one of the special word index value and the normal word index value held in the combination table 51. In this exemplary embodiment, the index value of each processing unit is calculated using at least one of the specific word of the polite expression and the specific word of the impolite expression having the same meaning in each combination, and then as a result, the point of change is detected. In this exemplary embodiment, it is possible to reduce the specific word data to be processed, resulting in reduction of the processing load.

### Other Exemplary Embodiments

In each of the exemplary embodiments, the telephone call data is handled, but the dissatisfying conversation determination device and the dissatisfying conversation determination method are applicable to a device and a system handling data of conversations other than telephone calls. In this case, for example, a recording device that records a conversation to be an analysis target is disposed in a place (a conference room, a teller window of bank, a cash register of a shop, or the like). In case that the conversation data is recorded in a state where the voices of the plurality of conversation participants are mixed, the conversation data is separated to the voice data for each conversation participant from the mixed state by predetermined voice processing.

In the plurality of flowcharts used in the above description, the plurality of steps (processing operations) are sequentially described, but an execution order of steps executed in the present exemplary embodiment is not limited to the described order. In the present exemplary embodiment, the order of steps illustrated may be modified without content problems. Further, any of the exemplary embodiments and any of the modified examples may be combined without conflicting contents.

A part or all of the exemplary embodiments and the modified examples may be identified as the following supplementary notes. However, the exemplary embodiments and the modified examples are not limited to the following description.

### (Supplementary Note 1)

A dissatisfying conversation determination device includes:

a data acquisition unit that acquires a plurality of word data extracted from voices of a target conversation participant in a target conversation and a plurality of phonation time data representing a phonation time of each word by the target conversation participant;

an extraction unit that extracts a plurality of specific word data each configuring a polite expression or an impolite expression from the plurality of word data acquired by the data acquisition unit;

a change detection unit that detects a point of change from the polite expression to the impolite expression of the target conversation participant in the target conversation, based on the plurality of specific word data extracted by the extraction unit and the plurality of phonation time data regarding the plurality of specific word data; and

a dissatisfaction determination unit that determines whether the target conversation is a dissatisfying conversation by the target conversation participant based on a detection result of the point of change by the change detection unit.

### (Supplementary Note 2)

The dissatisfying conversation determination device according to Supplementary note 1, further includes

a target determination unit that determines, as a target interval for analyzing a dissatisfaction of the target conversation participant, an interval having a predetermined width in the target conversation in which the point of change detected by the change detection unit is designated as an end.

### (Supplementary Note 3)

The dissatisfying conversation determination device according to Supplementary note 2, wherein the change detection unit further detects a point of return from the impolite expression to the polite expression in the target conversation with respect to the target conversation participant based on the plurality of specific word data extracted by the extraction unit and the plurality of phonation time data regarding the plurality of specific word data, and

the target determination unit further determines, as the analysis target interval, an interval in the target conversation in which the point of change is designated as a beginning and the point of return is designated as an end, the points being detected by the change detection unit in the target conversation.

### (Supplementary Note 4)

The dissatisfying conversation determination device according to Supplementary note 2 or Supplementary note 3, wherein the change detection unit includes:

an index value calculation unit that calculates an index value representing politeness or impoliteness for each processing unit, the processing unit is the specific word data included in a predetermined range among the plurality of specific word data arranged in the chronological order based on the plurality of phonation time data and is specified by sequentially sliding the predetermined range in the chronological order at a predetermined width; and

an identification unit that identifies adjacent processing units in which a difference of the index values between processing units adjacent to each other exceeds a predetermined threshold,

the change detection unit detects at least one of the point of change and the point of return based on the adjacent processing units identified by the identification unit.

### (Supplementary Note 5)

The dissatisfying conversation determination device according to Supplementary note 4, wherein the index value calculation unit acquires combination information representing combination of the specific word of the polite expression and the specific word of the impolite expression having the same meaning among the plurality of specific words each configuring the polite expression or the impolite expression, and calculates the index value of the each processing unit by treating a combination in which both the specific word of the polite expression and the specific word of the impolite expression are included in the plurality of specific word data among the plurality of combinations included in the combination information, separately from other specific word data.

### (Supplementary Note 6)

The dissatisfying conversation determination device according to Supplementary note 4 or Supplementary note 5, wherein the index value calculation unit acquires each of word index values representing politeness or impoliteness with respect to the respective specific word data included in the each processing unit, and calculates a total value of the word index values for the each processing unit as the index value.

### (Supplementary Note 7)

The dissatisfying conversation determination device according to Supplementary note 4 or Supplementary note 5, wherein the index value calculation unit counts a number of the specific word data included in the each processing unit for each polite expression and each impolite expression, and calculates the index value for the each processing unit based on a count number of polite expression and a count number of impolite expression in the each processing unit.

### (Supplementary Note 8)

The dissatisfying conversation determination device according to any one of Supplementary note 4 to Supplementary note 7, wherein the predetermined range and the predetermined width are specified using the number of the specific word data, a time period, or a number of utterance interval.

### (Supplementary Note 9)

A dissatisfying conversation determination method performed by at least one computer, the method includes:

acquiring a plurality of word data extracted from voices of a target conversation participant in a target conversation and a plurality of phonation time data representing a phonation time of each word by the target conversation participant;

extracting a plurality of specific word data each constituting a polite expression or an impolite expression from the plurality of acquired word data;

detecting a point of change from the polite expression to the impolite expression of the target conversation participant in the target conversation, based on the plurality of specific word data extracted by the extraction unit and the plurality of phonation time data regarding the plurality of specific word data; and

determining whether the target conversation is a dissatisfying conversation by the target conversation participant based on a detection result of the point of change.

### (Supplementary Note 10)

The dissatisfying conversation determination method according to Supplementary note 9, further includes

determining, as a target interval for analyzing a dissatisfaction of the target conversation participant, an interval having a predetermined width in the target conversation in which the point of change detected by the change detection unit is designated as an end.

### (Supplementary Note 11)

The dissatisfying conversation determination method according to Supplementary note 10, further comprising:

detecting a point of return from the impolite expression to the polite expression in the target conversation with respect to the target conversation participant based on the plurality of specific word data extracted and the plurality of phonation time data regarding the plurality of specific word data; and

determining, as the analysis target interval, an interval in the target conversation in which the point of change is designated as a beginning and the point of return is designated as an end in the target conversation.

### (Supplementary Note 12)

The dissatisfying conversation determination method according to Supplementary note 10 or Supplementary note 11, further comprising:

calculating an index value representing politeness or impoliteness for each processing unit, the processing unit is the specific word data included in a predetermined range among the plurality of specific word data arranged in the chronological order based on the plurality of phonation time data and is specified by sequentially sliding the predetermined range in the chronological order at a predetermined width: and

identifying adjacent processing units in which a difference of the index values between processing units adjacent to each other exceeds a predetermined threshold,

wherein, detecting at least one of the point of change and the point of return based on the adjacent processing units identified by the identification unit.

### (Supplementary Note 13)

The dissatisfying conversation determination method according to Supplementary note 12, wherein in order to calculate the index value, acquiring combination information representing combination of the specific word of the polite expression and the specific word of the impolite expression having the same meaning among the plurality of specific words each configuring the polite expression or the impolite expression,

calculating the index value of the each processing unit by treating a combination in which both the specific word of the polite expression and the specific word of the impolite expression are included in the plurality of specific word data among the plurality of combinations included in the combination information, separately from other specific word data.

### (Supplementary Note 14)

The dissatisfying conversation determination method according to Supplementary note 12 or 13, in order to calculate the index value,

acquiring each of word index values indicating politeness or impoliteness with respect to the respective specific word data included in the each processing unit, and

calculating a total value of the word index values for the each processing unit as the index value.

### (Supplementary Note 15)

The dissatisfying conversation determination method according to Supplementary note 12 or 13, in order to calculate the index value,

counting a number of the specific word data included in the each processing unit for each polite expression and each impolite expression, and

calculating the index value for the each processing unit based on a count number of polite expressions and a count number of impolite expressions in the each processing unit.

### (Supplementary Note 16)

The dissatisfying conversation determination method according to any one of Supplementary notes 12 to 15, wherein the predetermined range and the predetermined width are specified using the number of the specific word data, a time period, or a number of utterance intervals.

### (Supplementary Note 17)

A program that causes at least one computer to perform the dissatisfying conversation determination method according to any one of Supplementary note 9 to Supplementary note 13.

### (Supplementary Note 18)

A computer-readable recording medium that records the program according to Supplementary note 17.

This application is based upon and claims the benefit of priority from Japanese patent application No. 2012-240755, filed on Oct. 31, 2012, the disclosure of which is incorporated herein in its entirety by reference.

What is claimed is:

1. A dissatisfying conversation determination device comprising:
a data acquisition unit that acquires a plurality of word data extracted from voices of a target conversation participant in a target conversation and a plurality of phonation time data representing a phonation time of each word by the target conversation participant;
an extraction unit that extracts a plurality of specific word data each configuring a polite expression or an impolite expression from the plurality of word data acquired by the data acquisition unit;
a change detection unit that detects a point of change from the polite expression to the impolite expression of the target conversation participant in the target conversation, based on the plurality of specific word data extracted by the extraction unit and the plurality of phonation time data regarding the plurality of specific word data; and
a dissatisfaction determination unit that determines whether the target conversation is a dissatisfying conversation by the target conversation participant based on a detection result of the point of change by the change detection unit.

2. The dissatisfying conversation determination device according to claim 1, further comprising
a target determination unit that determines, as a target interval for analyzing a dissatisfaction of the target conversation participant, an interval having a predetermined width in the target conversation in which the point of change detected by the change detection unit is designated as an end.

3. The dissatisfying conversation determination device according to claim 2, wherein the change detection unit further detects a point of return from the impolite expression to the polite expression in the target conversation with respect to the target conversation participant based on the plurality of specific word data extracted by the extraction unit and the plurality of phonation time data regarding the plurality of specific word data, and
the target determination unit further determines, as the analysis target interval, an interval in the target conversation in which the point of change is designated as a beginning and the point of return is designated as an end, the points being detected by the change detection unit in the target conversation.

4. The dissatisfying conversation determination device according to claim 2, wherein the change detection unit includes:
an index value calculation unit that calculates an index value representing politeness or impoliteness for each processing unit, the processing unit is the specific word data included in a predetermined range among the plurality of specific word data arranged in the chronological order based on the plurality of phonation time data and is specified by sequentially sliding the predetermined range in the chronological order at a predetermined width; and
an identification unit that identifies adjacent processing units in which a difference of the index values between processing units adjacent to each other exceeds a predetermined threshold,
the change detection unit detects at least one of the point of change and the point of return based on the adjacent processing units identified by the identification unit.

5. The dissatisfying conversation determination device according to claim 4, wherein the index value calculation unit acquires combination information representing combination of the specific word of the polite expression and the specific word of the impolite expression having the same meaning among the plurality of specific words each configuring the polite expression or the impolite expression, and calculates the index value of the each processing unit by treating a combination in which both the specific word of the polite expression and the specific word of the impolite expression are included in the plurality of specific word data among the plurality of combinations included in the combination information, separately from other specific word data.

6. The dissatisfying conversation determination device according to claim 4, wherein the index value calculation unit acquires each of word index values representing politeness or impoliteness with respect to the respective specific word data included in the each processing unit, and calculates a total value of the word index values for the each processing unit as the index value.

7. The dissatisfying conversation determination device according to claim 4, wherein the index value calculation unit counts a number of the specific word data included in the each processing unit for each polite expression and each impolite expression, and calculates the index value for the each processing unit based on a count number of polite expression and a count number of impolite expression in the each processing unit.

8. The dissatisfying conversation determination device according to claim 4, wherein the predetermined range and the predetermined width are specified using the number of the specific word data, a time period, or a number of utterance interval.

9. A dissatisfying conversation determination method performed by at least one computer, the method comprising:
acquiring a plurality of word data extracted from voices of a target conversation participant in a target conversation and a plurality of phonation time data representing a phonation time of each word by the target conversation participant;
extracting a plurality of specific word data each constituting a polite expression or an impolite expression from the plurality of acquired word data;
detecting a point of change from the polite expression to the impolite expression of the target conversation participant in the target conversation, based on the plurality of specific word data extracted by the extraction unit and the plurality of phonation time data regarding the plurality of specific word data; and
determining whether the target conversation is a dissatisfying conversation by the target conversation participant based on a detection result of the point of change.

10. The dissatisfying conversation determination method according to claim 9, further comprising
determining, as a target interval for analyzing a dissatisfaction of the target conversation participant, an interval having a predetermined width in the target conversation in which the point of change detected by the change detection unit is designated as an end.

11. The dissatisfying conversation determination method according to claim 10, further comprising:
detecting a point of return from the impolite expression to the polite expression in the target conversation with respect to the target conversation participant based on the plurality of specific word data extracted and the plurality of phonation time data regarding the plurality of specific word data; and
determining, as the analysis target interval, an interval in the target conversation in which the point of change is designated as a beginning and the point of return is designated as an end in the target conversation.

12. The dissatisfying conversation determination method according to claim 10, further comprising:
calculating an index value representing politeness or impoliteness for each processing unit, the processing unit is the specific word data included in a predetermined range among the plurality of specific word data arranged in the chronological order based on the plurality of phonation time data and is specified by sequentially sliding the predetermined range in the chronological order at a predetermined width: and
identifying adjacent processing units in which a difference of the index values between processing units adjacent to each other exceeds a predetermined threshold,
wherein, detecting at least one of the point of change and the point of return based on the adjacent processing units identified by the identification unit.

13. The dissatisfying conversation determination method according to claim 12, wherein in order to calculate the index value, acquiring combination information representing combination of the specific word of the polite expression and the specific word of the impolite expression having the same meaning among the plurality of specific words each configuring the polite expression or the impolite expression,
calculating the index value of the each processing unit by treating a combination in which both the specific word of the polite expression and the specific word of the impolite expression are included in the plurality of specific word data among the plurality of combinations included in the combination information, separately from other specific word data.

14. (canceled)

15. A dissatisfying conversation determination device comprising:
data acquisition means for acquiring a plurality of word data extracted from voices of a target conversation participant in a target conversation and a plurality of phonation time data representing a phonation time of each word by the target conversation participant;
extraction means for extracting a plurality of specific word data each configuring a polite expression or an impolite expression from the plurality of word data acquired by the data acquisition means;
change detection means for detecting a point of change from the polite expression to the impolite expression of the target conversation participant in the target conversation, based on the plurality of specific word data extracted by the extraction means and the plurality of phonation time data regarding the plurality of specific word data; and
dissatisfaction determination means for determining whether the target conversation is a dissatisfying conversation by the target conversation participant based on a detection result of the point of change by the change detection means.

16. A non-transitory computer readable recording medium that stores a computer program for a computer, the computer program causing the computer to execute:
acquiring a plurality of word data extracted from voices of a target conversation participant in a target conversation and a plurality of phonation time data representing a phonation time of each word by the target conversation participant;
extracting a plurality of specific word data each constituting a polite expression or an impolite expression from the plurality of acquired word data;
detecting a point of change from the polite expression to the impolite expression of the target conversation participant in the target conversation, based on the plurality of specific word data extracted by the extraction unit and the plurality of phonation time data regarding the plurality of specific word data; and
determining whether the target conversation is a dissatisfying conversation by the target conversation participant based on a detection result of the point of change.
